(19) United States
(12) Patent Application Publication
(10) Pub. No.: US 2008/0189400 A1
(43) Pub. Date: Aug. 7, 2008

(54) Measuring Client Access Licenses

(75) Inventors: Ross A. Norrie, Bellevue, WA (US); Mark Sterin, Redmond, WA (US)

Correspondence Address: LEE & HAYES PLLC, 421 W RIVERSIDE AVENUE SUITE 500, SPOKANE, WA, 99201, US

(73) Assignee: Microsoft Corporation, Redmond, CA (US)

(21) Appl. No.: 11/670,314

(22) Filed: Feb. 1, 2007

(51) Int. Cl. G06F 15/173

(52) U.S. Cl. 709/223

(57) ABSTRACT

Embodiments of measuring client access license (CAL) techniques are presented herein. In an implementation, a management service provides functionality to collect and centrally store configuration data from a plurality of clients in a network and topology data describing the arrangement of applications and servers in the network. Then, the collected configuration data and topology data may be combined to measure client access license (CAL) usage corresponding to licensed resources which are provided via the network.

### BACKGROUND

One way server value in an enterprise network is monetized is through client access licensing, for example “per-seat” licensing in which a customer pays for each client or user that accesses licensed resources provided by the server. One traditional technique to measure client access license (CAL) usage is to perform audits in which an audit staff may manually survey clients and/or users of the clients to determine which applications are installed and which licensed resources are accessed by the clients and/or users Naturally, determining CAL usage numbers via manual audits may be time consuming, frustrating, and expensive. Further, traditional techniques for measuring client access licenses have focused on determining which applications are installed on clients which may not provide accurate information as to which resources are actually being accessed by the clients and/or users. Thus, traditional techniques for measuring client access licenses may also have the disadvantage of not providing accurate results.

### SUMMARY

Measuring client access license techniques are described. In an implementation, a service collects a variety of configuration data from a plurality of clients which access licensed resources via one or more servers in an enterprise network. The service also collects topology data describing the interconnection of the servers and/or applications in the enterprise network. Based on the collected configuration and topology data, the service may generate license usage data indicating which clients and/or user of clients have accessed the licensed resources.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

FIG. 1 is an illustration of an environment in an implementation that is operable to employ measuring client access license techniques.

FIG. 2 is an exemplary implementation of an enterprise network in which a management service may be employed to measure client access license usage.

FIG. 3 depicts a procedure in an exemplary implementation in which client configuration data and topology data is collected and used to measure client access licenses.

FIG. 4 depicts a procedure in an exemplary implementation in which a management system uses agents deployed to clients and servers to collect data and measure client access licenses.

### DETAILED DESCRIPTION

Overview

Resources in an enterprise network may be licensed such that a customer purchases a client access license (CAL) for each device or client accessing the resources. Thus, measurement of CAL usage may be performed by customers or providers to plan a network, determine license compliance, charge for services, and so forth. However, traditional techniques to measure CAL usage have used manual audits which are time consuming and expensive and/or have focused on installed applications of clients which may provide inaccurate measurement of CAL usage.

In one or more embodiments, measuring client access license techniques are described in which client access license (CAL) usage for corresponding licensed resources is measured based upon configuration and topology data which may be centrally collected and analyzed. For example, a management service may be provided in an enterprise network to collect a variety of configuration data which describes connections of a plurality of clients to licensed resources through intermediate application servers and/or directly from resource servers which provided the resources. In an implementation, the configuration data may be collected from a configuration agent deployed to one or more of a plurality of clients in the network. Additionally, the management service may collect topology data which describes the arrangement of the network, such as describing the relationships between applications, intermediate application servers, resources, and/or resource servers in the network. In an implementation, the topology data may be collected from a topology agent deployed to one or more of the servers in the enterprise network.

The collected data may be maintained by the management service in centralized database which may be accessible via the network to perform data manipulation, analysis, queries, reports, and other database functions. In particular, the collected data may be used to measure client access license (CAL) usage. CAL usage may correspond to a tracking period and indicate either or both of the number of unique users (user CALS) or number of unique clients (device CALs) which access licensed resources during the tracking period.

In the following discussion, an exemplary environment is first described that is operable to employ the measuring client access license techniques described, as well as other techniques. Exemplary procedures are then described which may be employed by the exemplary environment, as well as in other environments.

Exemplary Environment

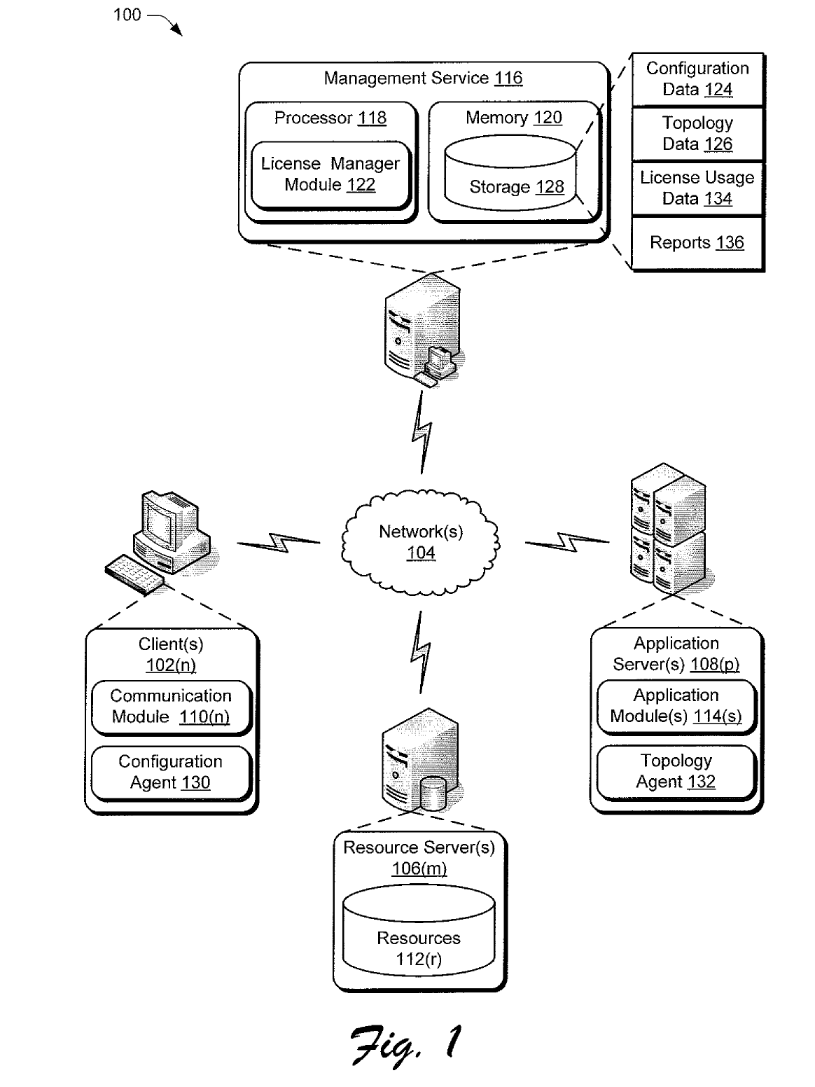

FIG. 1 is an illustration of an environment 100 in an exemplary implementation that is operable to employ measuring client access license techniques. The environment 100 may represent a managed network or portion thereof, such as an enterprise network. A managed or enterprise network typically includes a variety of clients which may access network resources, such as a variety of databases (e.g., production, orders, customers, quality, human resources, and so forth) from resource servers. Access to some resources may be according to a licensing scheme, for instance, using client access licenses (CALs) to permit access to server query language (SQL) databases or other databases, network applications, and/or other types of server-based resources. The access by clients to such “enterprise” resources may be through direct interactions with resource servers and/or via one or more intermediate application servers which may be implemented to provide “front-end” applications suitable for accessing the “back-end” resources.

Referring to FIG. 1, the example environment 100 is depicted as including one or more clients 102(n) (where “n” can be any integer) communicatively coupled over a network 104 to one or more resource servers 106(m) (where “m” can be any integer). Clients 102(n) may also be communicatively coupled via the network 104, to one or more application servers 108(p) (where “p” can be any integer) which may be configured to provide “front-end” applications to access the resource servers 106(m). The one or more clients 102(n) may be configured in a variety of ways for accessing a variety of resources (e.g., content, data, and/or services), including access to the resources servers 106(m) and application servers 108(p) via the network 104. For example, one or more of the clients 102(n) may be configured as a computing device, such as a desktop computer, a mobile station, an entertainment appliance, a set-top box communicatively coupled to a display device, a wireless phone, a game console, and so forth. Thus, the client devices 102(n) may range from full resource devices with substantial memory and processor resources (e.g., personal computers, game consoles) to low-resource devices with limited memory, processing and/or display resources (e.g., traditional set-top boxes, hand-held game consoles, wireless phones). Access of the clients 102(n) to the network 104 may occur via a wired or wireless connection. Clients 102(n) may also include one or more mobile devices which may be configured to intermittently connect to the network 104, such as laptops, personal digital assistants (PDAs), and so forth. Additionally, one or more of the client devices 102(n) may describe logical clients that include software and/or devices. Although illustrated as a single network 104, the depicted network 104 may represent multiple networks and can be implemented in a wide variety of configurations. For example, the network 104 may represent various combinations of networks including one or more of a wide area network (WAN), a local area network (LAN), a wireless network, a public telephone network, an intranet, the Internet, and so on.

The clients 102(n) are each illustrated as including a respective communication module 110(n). The communication modules 110(n) are representative of a variety of functionality for clients 102(n) to communicate via the network 104, including functionality which is executable by the clients 102(n) to interact with resources 112(r) which may be provided via the network 104. A variety of resources 112(r) are illustrated as being stored at and/or provided via the resource servers 106(m).

The illustrated resources 112(r) are representative of a variety of content, data, and services which may be provided in a managed/enterprise network. Examples of resources 112(r) which may be provided via the resource servers 106(m) include, but are not limited to, order data, scheduling data, assets data, production/manufacturing data, quality data, customer data, financial information, inventory, logistics, human resources and combinations thereof. In an implementation, the illustrated environment 100 may represent an enterprise resource planning (ERP) system or a portion thereof which integrates a variety of data and processes into a unified system. Those of skill in the art will appreciate numerous other examples of resources 112(r) which may be integrated in an ERP system, as well as provided in other managed networks. Resources 112(r) may include both licensed and unlicensed resources. In an implementation, the application servers 108(p) may be configured to provide one or more application modules 114(s) which may be configured as “front-end” applications through which clients 102(n) access the “back-end” resources 112(r). Additionally or alternatively, the access to resources 112(r) may be directly between clients 102(n) and resource servers 106(m), e.g., without the use of intermediate applications servers 108(p) and/or the associated application modules 114(s).

Accordingly, the communication modules 110(n) of a client 102(n) may be configured in a variety ways to access the resources 112(r) from the resource servers 106(m) as well as accessing other resources, such as Internet content. In an embodiment, a communication module 110 of a client 102 may be configured to provide browser functionality to access and interact with a variety of resources 112(r) (e.g., content, data and/or services) available via the network 104. For instance, the communication modules 110(n) may provide the clients 102(n) an interface to interact via the network 104 with one or more of the “front-end” applications 114(s) provided by the application servers 108(p). Each of the application 114(s) may be associated with and provide access to certain resources 112(r). The one or more “front-end” applications 114(s) may be executed to generate browser renderable pages which, when communicated via the network 104 to the clients 102(n), may be output by the communication module 10(n) to provide the interactions/access with associated “back-end” resources 112(r) which are maintained via the resource servers 106(m). For example, one of the applications 114(s) may be configured as a browser accessible human resources program which provides client access to resources 112(r) such as an employee database, benefits information, health care data, retirement accounts, and other human resources data. Additional examples of functionality which may be provided by application modules 114(s) include, but are not limited to, database queries and data manipulation, home/office/business productivity functionality such as word processing, spreadsheet, and presentation functionality; database reporting, email, software development functionality such as development interfaces, tools, management, and compilation; and other computing functionality such as graphic design, and media management, editing, viewing, and/or playback. Each of the application modules 114(s) may accordingly provide access to corresponding resources 112(r). For instance, a human resource (HR) application may provide access to HR databases, a quality control (QC) application to QC data, an accounting application to financial data, and so on. A variety of other examples of enterprise applications 114(s) and corresponding resources 112(r) are also contemplated. Each of the application 114(s) may include settings which direct the respective application 114 to one or more of the resources servers 106(m) to access corresponding resources 112(r).

While applications 114(s) provided by the application servers 108(p) have been described, it is contemplated that the functionality of the applications 114(s) may also be provided via the clients 102(n) themselves, such as being integrated with the communication modules 110(n). In this manner, the clients 102(n) may directly access the resources 112(r) from resource servers 106(m), rather than using the intermediate application servers 108(p). Accordingly, in an embodiment, communication modules 110(n) may represent communication functionality associated with one or more application 114(s), which in this instance are implemented as client-based applications. For instance, as an alternative to the browser based HR application described in the preceding example, a communication module 110(n) may be implemented as a component of a client-based human resources application which integrates the communication functionality of the communication module 110(n) with application functionality of one or more applications 114(s) to access, obtain, and manipulate human resources data directly from one or more of the resource servers 106(m).

Communication modules 110(n) may further be configured to cause authentication of clients 102(n) to access corresponding resources 112(r) (e.g., to determine that clients 102(n) and/or users seeking access to resources provided via network 104 “are who they say they are”), and so on. Clients 102(n) and/or users of the clients 102(n) may provide account credentials (e.g., username and password) via the communication module 110(n) to access the resources 112(r). A variety of authentication schemes and techniques are contemplated.

Thus, the clients 102(n) in the described environment 100 may access resources 112(r) in a variety of ways including both direct and indirect manners. As noted, access to certain “licensed” resources may be according to a licensing scheme, one example of which is “per-seat” licensing in which customers (e.g., businesses) may be charged for each unique client 102(n) and/or user accessing the licensed resources from a provider. A client access license (CAL) may be consumed by a customer for each device or user using the corresponding licensed resources 112(r). Client access licenses (CALs) may be based on either or both of unique clients 102(n) (device CALs) and unique users of the clients 102(n) (user CALs) which access corresponding resources. An example “per-seat” license agreement for an SQL database server may permit 200 unique clients 102(n) to access the database during a set time period, such as in 90 days. Thus, customers and providers may each be interested in measuring the number of clients and/or users accessing licensed resources (e.g., measuring CAL usage) in order to determine license compliance, charge for services, plan and/or upgrade a network, and so forth.

Accordingly, measuring client access license (CAL) techniques are described in which a variety of system data regarding the clients 102(n), servers 106(m), 108(p), associated applications 114(s), connections in the system, and so forth may collected and utilized to measure CAL usage. In an implementation, a management service 116 is provided which represents a variety of functionality to manage the depicted enterprise network, including functionality for measuring client access license (CAL) usage. The management service 116 provides centralized and automatic collection of system data for measuring CAL usage. The management service 116 is depicted as including a processor 118 and a memory 120. Naturally, each of the clients 102(n), servers 106(m) and 108(p) in the environment 100 may be implemented as computing devices which each may have respective processor(s) and memory(s) to execute and store various modules. The management service 116 includes a license manager module 122 which may be executed on the processor 118 and is also storable in the memory 120. The license manager module 122 represents functionality integrated with the management service 116 to perform measuring client access license (CAL) techniques. More particularly, the license manager module 122 may include, but is not limited to, functionality to collect a variety of data from the components in the environment 100, perform analysis and combinations of the collected data, determine based on the data and analysis how the components in the environment are interconnected, and determine (e.g., measure), based on the collected data, client access license (CAL) usage. It is noted that while illustrated separately, the management service 116 may be implemented as one or more modules incorporated with and executed via one or more of the resources servers 106(m), application servers 108(p), or even via one or more of the clients 102(n).

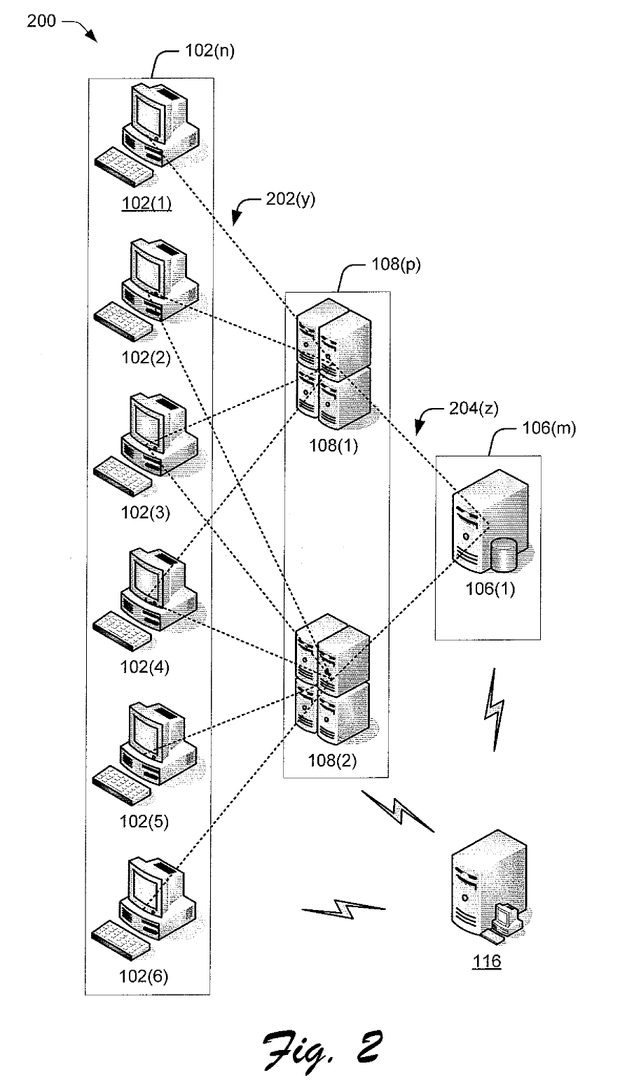

It is contemplated that a variety of data may be collected by the management service 116 which may be useful in determining CAL usage. For instance, the management service 116 in FIG. 1 is illustrated as storing a variety of configuration data 124 and topology data 126 in storage 128 (e.g., a database) within the memory 120. The license manager module 122 may operate to collect the data, maintain data in the storage 128, and to manage the collected data. Configuration data 124 as used herein generally refers to data regarding the clients 102(n), configuration of the clients 102(n), and connections of the clients 102(n). Topology data 126 as used herein describes data indicating how various the various components (e.g., servers 106(m), 108(p), resources 112(r), applications 114(s), and so forth) are arranged and/or interconnected in the network 104. Additional details regarding the configuration data 124 and topology data 126 which may be collected by the management service 116 to perform measuring client access license techniques may be found in relation to FIGS. 2-4 below.

In operation, management service 116 may collect and centrally store a variety of configuration data 124 from the plurality of clients 102(n) which may access resources 112(r) via corresponding servers 106(m), 108(p) in an enterprise or other network. The management service 116 may also collects topology data 126 describing the interconnection of the servers 106(m), 108(p) and/or clients 102(n) in the network. In an implementation, a configuration agent 130 may be deployed to one or more of the clients 102(n) which provides functionality to collect corresponding configuration data 124 and to communicate the collected data via network 104 to the management service 116. Likewise, a topology agent 132, which represents functionality to collect topology data 126 and to communicate the collected data via network 104 to the management service 116, may be deployed to one or more of the application servers 108(p) and/or resource servers 106(m). While depicted as deployed to the clients 102(n) and application servers 108(p) respectively, the configuration agent 130 and topology agent 132 may alternatively each be integrated with the license manager module 122 and executed via the management service 116 to interrogate clients 102(n) and/or servers 106(m), 108(p) over the network 104 to obtain the configuration data 124 and topology data 126.

Based on the collected configuration data 124 and topology data 126, the management service 116 performs analysis through which the CAL usage may be determined. For instance, the management service 116 may generate license usage data 134 indicating which clients 102(n) and/or users of the clients 102(n) have accessed the licensed resources, based on the collected data. The license usage data 134 may be for a particular time frame or tracking period. For instance license usage data 134 may summarize the collected data during one or more tracking periods, which may be set by a license agreement. The license usage data 134 may include counters, summary records, device CAL, user CAL, periodically collected CAL usage, snapshot or instantaneous CAL usage and so forth. Thus, license usage data 134 generated by the management service 116 may represents results from various processing of the collected data (e.g., configuration data 124 and topology data 126). Further, the collected data and/or license usage data 134 may also be used to output a variety of reports 136. The management service 116 is illustrated as producing reports 136 which may be accessed on demand, periodically generated, automatically sent to recipients, and so forth. Reports 136 may be formed which present CAL usage data in a variety of ways including instantaneous CAL usage data (e.g., “snapshot” data), historical trends, plots, graphical representation, and so forth. Further, one or more reports 136 may be alert based, such that an “alert” report 136 is generated, output, and/or sent to selected recipients when a predetermined threshold CAL usage is approached or met.

Processors are not limited by the materials from which they are formed or the processing mechanisms employed therein. For example, processors may be comprised of semiconductor(s) and/or transistors (e.g., electronic integrated circuits (ICs)). In such a context, processor-executable instructions may be electronically-executable instructions. Alternatively, the mechanisms of or for processors, and thus of or for a computing device, may include, but are not limited to, quantum computing, optical computing, mechanical computing (e.g., using nanotechnology), and so forth. While in places herein a single processor may be depicted or described, multiple processor arrangements are contemplated such as a processor core which includes a variety of processing devices. Likewise, while a single memory may be shown or described for a component, a wide variety of types and combinations of memory may be employed, such as random access memory (RAM), hard disk memory, removable medium memory, and other computer-readable media.

Generally, any of the functions described herein can be implemented using software, firmware (e.g., fixed logic circuitry), manual processing, or a combination of these implementations. The terms “module,” “functionality,” and “logic” as used herein generally represent software, firmware, or a combination of software and firmware. In the case of a software implementation, the module, functionality, or logic represents program code that performs specified tasks when executed on a processor (e.g., CPU or CPUs). The program code can be stored in one or more computer readable memory devices. The features of the measuring client license access techniques described below are platform-independent, meaning that the techniques may be implemented on a variety of commercial computing platforms having a variety of processors.

FIG. 2 is an illustration of a system 200 in an exemplary implementation showing an example set of connections between components which may exist in an enterprise network. The clients 102(n) are illustrated as having connected to application servers 108(p) via a plurality of connections 202(y). The application servers 108(p) are illustrated as having connected to the resource servers 106(m) via a plurality of connections 204(z). By way of example and not limitation, six clients 102(1)-102(6), two application servers 108(1)-108(2), and one resources server 106(1) are illustrated. Naturally, a variety of arrangements in which there are fewer or greater numbers of clients 102(n), application servers 108(p), and/or resource servers 106(m) are contemplated.

In the depicted arrangement, the six clients 102(1)-102(6) each access the resource server 106(1). Thus, the proper count of device CALs in this arrangement is six. However, the server itself 106(1) sees only the two connections from the application servers 108(1)-108(2) which may be configured to provide “front-end” applications which act to multiplex associated resources 112(r) for the clients 102(n). Thus, the connections 204(z) may not provide the proper measurement of CALs. The application server 108(1)-108(2) see a total of nine connections 202(y), with server 108(1) seeing four individual connections corresponding to clients 102(1)-102(4) and server 108(2) seeing five individual connections corresponding to clients 102(2)-102(6). Thus, the connections 202(y) may also not provide the proper measurement of CALs. Thus, neither the application servers 108(p) nor the resource servers 106(m) may use the number of respective connections to directly measure an accurate CAL number. Further, simply determining the applications installed on the clients 102(n) may not correspond to actual CAL usage since installed applications may go unused Further, when network multiplexing devices (e.g., routers) are employed for a group of clients 102(m), internet protocol (IP) addresses may be masked to the accessed servers by Network Address Translation (NAT), such that the servers sees only the address of the multiplexing device. Still further, emerging technology and protocols such as Internet Protocol (IP) Version 6 (IPV6) are directed at shifting IP addresses for security and privacy reasons. Thus, IP addresses may not be static and the number of unique IP addresses accessing a set of resources may not correlate to the actual number of unique clients 102(m) accessing the set of resources Accordingly, tracking unique IP addresses of clients 102(m) may not provide accurate CALs usage. Thus, traditional techniques for measuring CALs such as relying upon installed applications, IP addresses, and/or directly using server connections to measure CALs may be difficult, inaccurate or even impossible.

Accordingly, the management service 116 may be provided to perform measuring client access license (CAL) techniques in which a variety of system data is centrally collected and utilized to measure CAL usage. For instance, the management service 116 may collect, manage, combine, and analyze system data such as configuration data 124 and topology data 126 of FIG. 1. This collected data may then be used to measure a proper and accurate count of client access license (CAL) usage. Configuration data 124 regarding client in this instance may be collected and used to enumerate the connections 202(y) between the clients 102(n) and the application servers 108(p). Configuration data 124 may further include authentication data indicating which users are using the clients 102(n), and to which servers and/or resources 112(r) these users are connecting. The collected topology data 126 may be used to enumerate the connections 204(z). Thus, taken together the collected data may indicate the servers to which clients and/or users are connected, and the interrelation of the clients 102(n), servers 106(m) 108(p), applications 114(s) and resources 112(r) in the network 104. Accordingly, based on the collected data the management service 116 and/or license manger module 122 may measure the number of CALs. Resulting license usage data 132 may be generated, such as an instantaneous “snapshot” of the current CAL usage and/or CAL usage over a defined tracking period. Both device CALs and user CALs may be measured. The license manger module 122 may further provide functionality to report the data, which may even include generating a report 134 which includes a topology diagram illustrating the various connections and/or CAL usage, such as the diagram shown in FIG. 2 or other visual representations of CAL usage. Further discussion of measuring client access license (CAL) techniques may be found in reference to the following procedures.

Exemplary Procedures

The following discussion describes techniques for measuring client access licenses that may be implemented utilizing the previously described systems, interfaces, and devices. Reference will be made in the course of the discussion of the following procedures to the environment depicted in FIG. 1 and the system depicted in FIG. 2. Aspects of each of the procedures may be implemented in hardware, firmware, or software, or a combination thereof. The procedures are shown as a set of blocks that specify operations performed by one or more devices and are not necessarily limited to the orders shown for performing the operations by the respective blocks.

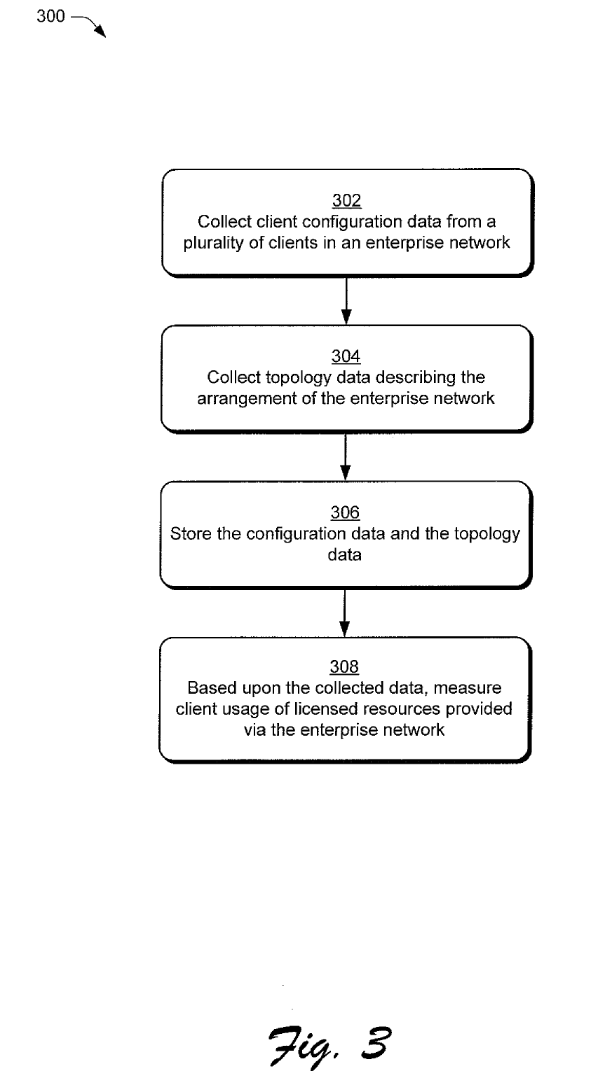

FIG. 3 depicts a procedure 300 in an exemplary implementation in which a management service collects configuration data and topology data to measure client access license (CAL) usage. In block 302, configuration data is collected from a plurality of clients in an enterprise network. For example, an enterprise network as depicted in FIG. 1 may include a plurality of clients 102(n). In an implementation, a license manager module 122 may be executed by processor 118 of the management service 116 to collect various configuration data 124. As previously described, license manger module 122 may operate to directly interrogate the clients 102(n) via the network 104 to obtain the configuration data 124. In an implementation, the license manager module 122 may operate in conjunction with configuration agents 130 deployed to one or more of the clients 102(n) which provide functionality to collect data and communicate the data to the license manger module 122. The license manager module 122 may then receive the communicated data, which may be stored in storage 128 which may be representative of a license usage database maintained in memory 120. Communication of data including configuration data 124 between clients 102(n) and the management service 116 (e.g., license manger module may be according to a variety of communication techniques and protocols, such as Simple Object Access Protocol (SOAP), an extensible markup language (XML) or other markup language schema, and/or other suitable client-server communication protocols and techniques. Thus, the management service 116 may operate to collect and/or store a variety of configuration data 124 from clients 102(n) in an enterprise network 104, as well as in other network settings.

As noted previously a variety of configuration data 124 is contemplated which may be useful in determining CAL usage. Configuration data 124 may encompass a variety of data related to the clients 102(n). In various types of configuration data 124, clients 102(m) may maintain various persistent information which indicates which resources 112(r), applications 114(s), resource servers 106(m), and/or application servers 108(p) the clients 102(m) are configured to access. Such data may include, but is not limited to, enumeration of the applications installed on a client 102, application settings specifying which of the servers 106(m) or 108(p) the applications are directed to access, registry settings which may store server identifying information, browser history which may indicate uniform resource locators (URL) and/or internet protocol (IP) addresses to which the browser has been directed. In addition, the clients 102(n) may maintain log files which may indicate which applications have been executed as well as how often and when they are executed. Thus, the a configuration agent 130 deployed to a client 102 may collect a variety of configuration data 124 which enumerates the applications installed at a client 102, which of the installed applications are used by the client 102, when the applications arc used, and additionally the servers in the network 104 to which the applications and accordingly the clients 102(n) connect.

In an implementation, configuration data 124 may further include authentication data indicating which users of the clients 102(n) have “logged-in”, executed particular applications, accessed resources 112(r), and so forth. For example, the configuration agent 130 may be configured to intercept authentication data in authentication sequences or to use authentication logs to obtain data which may indicate which resources 112(r) a client has been authorized to access based on the clients 102(n) or users providing authentication credentials (e.g., username and password). The configuration agent 130 may, for instance, track the number of unique usernames which are used on a client 102 to access resources 112(r). This tracking may be anonymous such that the configuration agent 130 tracks the number of unique usernames which are used on the client 102, but may not know or collect the actual username or other user credentials which have been used. For example, the configuration agent 130 may be configured to perform a username comparison and to increment a counter each time a unique username is discovered. Thus, authentication data indicating unique users of a client 102 may be used to enumerate user CALs and to distinguish user CAL from device CAL. Further, it is possible to intercept transactional data when a client 102 actually connects to a server, e.g., to intercept client-server hand shake data. This may indicate actual connections of the clients 102(n) to the servers 106(m) or 108(p). Thus, various configuration data 124, alone or in combination, may be collected which may be utilized to determine the servers and/or application 114(s) to which clients 102(m) and/or user are connected.

Referring to FIG. 2 for example, collected configuration data 124 may be used to enumerate the connections 202(y) between the clients 102(n) and application servers 108(p) and/or corresponding application 114(s), and to correlate the connections 202(y) to unique users of the clients 102(n). Since, in the system of FIG. 2, the application servers 108(m) are employed, the configuration data 124 alone may not be sufficient to measure CAL usage. Thus, in accordance with techniques described herein, the connections 202(y) arrived at via the configuration data 124 may be correlated to resources 112(r) and corresponding servers 106(m) by topology data 126 describing the arrangement of the network.

Accordingly, in block 304, topology data is collected which describes the arrangement of the network. For example, an enterprise network as depicted in FIG. 1 may include a plurality of servers such as the resource servers 106(m) and application servers 108(p). Various additional server tiers such as Internet or Intranet servers may also be provided. Thus, connections of a client 102 to resources 112(r) may occur in numerous ways either directly or routed through one or more intermediate servers and/or server tiers.

In an implementation, a license manager module 122 may be executed by processor 118 of the management service 116 to collect various topology data 126 from the various servers 106(m), 108(p) as well as from the clients 102(n). As previously described, license manger module 122 may operate to directly interrogate the servers via the network 104 to obtain the topology data 126. In an implementation, the license manager module 122 may operate in conjunction with topology agents 130 deployed to one or more of the servers which provides functionality to collect topology data 126 and to communicate the data to the license manger module 122. The license manager module 122 may then receive the communicated topology data 126, which may be stored in storage 128 which may be representative of a license usage database maintained in memory 120. As with the configuration data 124, communication of topology data 126 between servers 106(m), 108(p) and the management service 116 (e.g., license manger module may be according to a variety of communication protocols. Thus, the management service 116 may also operate to collect and/or store a variety of topology data 126, which describes the interconnections and/or arrangement of components in the network 104. Referring again to FIG. 2 for example, collected topology data 126 may be used to enumerate to connections 204(z) between the resource servers 106(m) and application servers 108(p) and/or corresponding application 114(s).

Topology data 126 as used herein generally refers to a variety of data which describes the interconnection of servers 106(m), 108(p) and applications 114(s) in a network 104. The configuration data 124 described above may be sufficient to understand which applications 114(s) and application servers 108(p) are used by clients 102(n) and/or users. Topology data 126 supplements the configuration data 124 by indicating how those applications 114(s) and application servers 108(p) are arranged and/or interconnected in a network 104, such as which resources servers 106(m) and resources 112(r) each of the applications 114(s) and application servers 108(p) are configured to access. Thus, configuration data 124 and topology data 126 may be combined to provide an overall picture of connections in a enterprise network, and accordingly may be the basis for measuring CAL usage.

A variety of topology data 126 is contemplated which may be useful for determining CAL usage. For instance, to access the correct servers in the network 104, settings of the application servers 108(p) and/or corresponding applications 114(s) may maintain persistent data which may be used identify the respective servers (e.g., resources servers 106(m)) to which they connect, e.g. topology data 126. In an implementation, a topology agent 132 deployed to the servers 108(m), or which is alternatively integrated with the management service 116, may be executed to intercept/collect the topology data 126. It is noted that collection of topology data 126 may occur before, after, or concurrently with the collection of configuration data 124. Additional examples of topology data 126 which may be collected include, but are not limited to, internet protocol (IP) addresses of servers from applications 114(s) or settings of the servers 108(p), uniform resource locators (URL) from browser based applications 114(s), server names, web addresses, application settings matching applications 114(s) to particular resource servers 106(m) and/or resources 112(r), and so on. By way of example, topology data 126 may be collected which identifies one of the resource servers 106(m) which is used to store data for a particular human resources application provided by one of the applications servers 108(m), or which indicates a particular SQL database which is used by an application 114(s) configured for quality control management, or which matches a financial planning application to a particular set of resources 112(r), and so forth. A variety of other examples of topology data 126 are also contemplated.

In block 306, the collected data is stored. For instance, the collected configuration data 124 and topology data 126 may be maintained in storage 128 configured as a database in memory 120 of the management service 116 or in other suitable storage. License manager module 122 may provide functionality to perform operations to store, access, update, delete, and otherwise manipulate the data. The stored data may be made accessible via the network 104 for further processing and manipulation, such as to obtain reports 136 which may be generated via the management service, or by external applications executed by clients 102(n), the application servers 108(p) and so forth.

In block 308, client access license usage is measured based upon the collected data. For instance, collected data (configuration data 124 and topology data 126) may be processed subsequent to being received to measure CAL usage. In an implementation, a variety of counters may be maintained to track CAL usage for different corresponding resources 112(r) or groups of resources, different tracking periods, different types of CALs (e.g. user or device), and so forth. These counters or other forms of tracking information may be included with license usage data 134 to track unique device and/or client connections to corresponding resources. The counters may be incremented each time data provided by the clients 102(n) and servers 108(p), 106(m) indicates that a unique device or user has accessed corresponding resources 112(r). After, a specified measurement period has passed, the counters may be reset. License usage data 134 may be configured in a variety of other ways to express CAL usage corresponding to resources 112(r) and may include various statistical and calculated values such as average CAL usage, maximum or minimum CAL during a tracking period, rolling tracking period statistics, summarized data, and so forth.

In addition, reports 136 may be produced from the collected data and/or license usage data to measure and/or summarize CAL usage. Reports 136 may list or summarize the connections of clients 102(n) to resources 112(r) in the network 104. Numerous reports 136 in a variety of formats may be generated, based on the collected data, to indicate which clients 102(n) have connected to which resources 112(r), to measure/indicate the number of clients 102(n) and/or users, and so forth. In addition, license usage data 134 and/or reports 136 may indicate how the connections of clients 102(n) to the resources 112(r) are made, such as which applications 114(s) and servers 108(p), 106(m) are used, as well as which users of the clients 102(n) have obtained access to the resources 112(r) Reports 136 may be ad hoe, automatically generated “canned” reports, generated in response to a predetermined CAL threshold or limit, and so forth. Reports may be user initiated by or automatically produced such as by the license manager module 122. In an implementation, the generation of reports and/or license usage data 134 from collected data may occur without storing the underlying collected data. Thus, optionally the collected data is processed to generate results (license usage data and/or reports 136) proximate to the time at which it is received and the storage in block 306 may be omitted. This may be beneficial where storage space is limited and/or where summarized CAL usage results are deemed sufficient.

Again using FIG. 2 as an example, configuration data 124 and topology data 126 collected for the particular system 200 may be combined/analyzed to correlate the connections 204(z) to the connections 202(y). For instance, client 102(1) may execute a communication module 110(n) to access a financial data application from an application server 108(1). Configuration data 124 from a configuration agent 130 of client 102(1) may indicate that the communication module 108 is configured to access the server 108(1). The financial data application may be configured to connect to resources 112(r) from a particular server, such as resource server 106(1) Topology data 126 collected from the application server 108(1) indicates that the financial data application connects to the resource server 106(1) to obtain corresponding resources 112(r), such as business sales or cost data. The license manager module 122 may be executed to process the collected data and to enumerate the connection of client 102(1) to resource server 108(1) and associated resources 112(r). Each connection of the clients 102(n) in FIG. 2 may be enumerated in a similar fashion to measure CAL usage for the system 200.

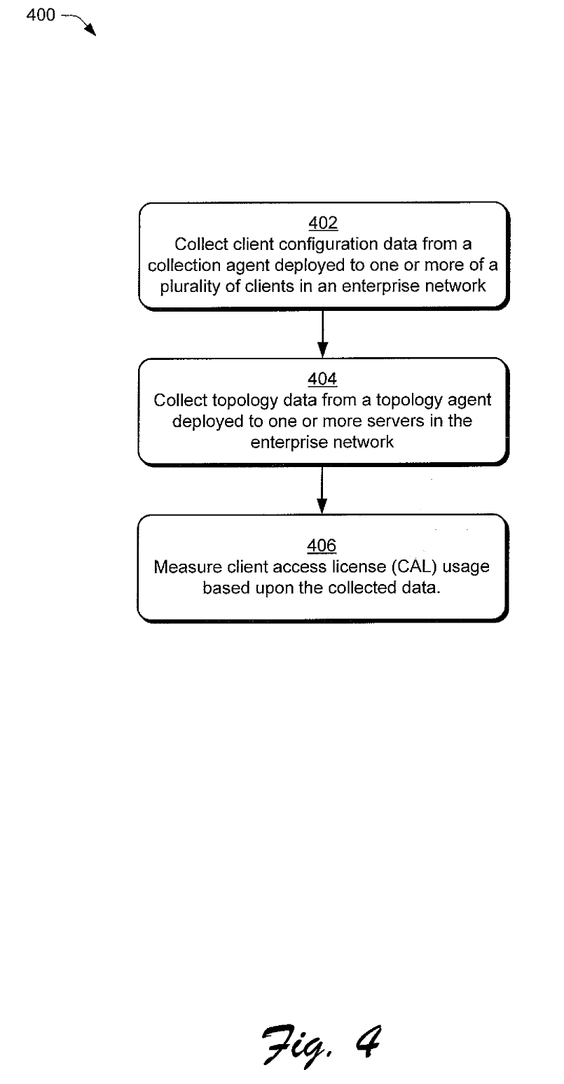

FIG. 4 depicts a procedure 400 in an exemplary implementation in which client access license (CAL) usage is measured based upon collected configuration and topology data. In block 402, client configuration data is collected from a configuration agent deployed to one or more of a plurality of clients in an enterprise network. In block 404, topology data is collected from a topology agent deployed to one or more servers in the enterprise network. In block 406, client access license usage is measured based upon the collected data.

For example, the management service 116 of FIG., through execution of the license manger module 122, may collect configuration data 124 from a configuration agent 130 deployed to clients 102(n) as well as topology data 126 from a topology agent deployed to one or more of the application servers 108(p). The data may be maintained in centralized storage 128 as illustrated in FIG. 1. The storage 128 may be configured as a database which may be accessible to perform data manipulation, analysis, queries, reports and other database function. In particular, the collected data may be used to measure client access license (CAL) usage for either or both of user CALS or device CALs. For instance, the collected configuration data 124 and topology data 126, may be used to generate license usage data 134 as well as reports 136. License usage data 134 may be configured in a variety of ways to indicate the number of clients 102(n) (and/or users of the clients 102(n)) which have accessed resources 112(r) over a specified tracking period of time. As an illustrative example, license usage data 134 corresponding to the system of FIG. 2, may indicate that six clients 102(1)-102(6) accessed resources of the resource server 106(1) over a one month period of time. Based on user authentication information from the configuration data 124, the license usage data 134 data may further indicate that nine unique users accessed resources of the resource server 106(1) in the same period using the clients 102(1)-102(6). In this manner, both device and user CAL may be determined. Naturally, license usage data 134 may be generated for numerous clients 102(n), resources 112(r), and resources servers 106(m) which may be employed with or without application servers 108(p) or other intermediate servers. A variety of other examples are also contemplated.

### CONCLUSION

Although embodiments of measuring client access license techniques have been described in language specific to features and/or methods, it is to be understood that the subject matter of the appended claims is not necessarily limited to the specific features or methods described. Rather, the specific features and methods are disclosed as example implementations of measuring client access licenses techniques.

What is claimed is:

1. A method comprising:
collecting configuration data describing connections of a plurality of clients in an network to one or more applications through which the plurality of clients access licensed resources from one or more resource servers;
collecting topology data describing relationships between the one or more applications and the licensed resources from the one or more resource servers; and
based upon the collected configuration data and topology data, measuring client access license usage corresponding to the licensed resources.

2. The method as recited in claim 1, wherein the network is an enterprise network.

3. The method as recited in claim 1, wherein:
the one or more applications are provided by one or more applications servers; and
the topology data is to correlate the one or more application servers to corresponding licensed resources from the one or more resource servers.

4. The method as recited in claim 3, wherein the measuring client access license usage further comprises for each of the plurality of clients:
based upon the configuration data, determining which applications and application servers are accessed by the respective client during a tracking period; and
based upon the topology data, determining which licensed resources are accessible via each of the applications and application servers which are accessed by the respective client, such that the configuration data and topology data when combined indicates which of the licensed resources are accessed by each of the clients during the tracking period.

5. The method as recited in claim 1, wherein the client access license usage measures the number of unique clients which access the licensed resources during a tracking period.

6. The method as recited in claim 1, wherein the client access license usage measures the number of unique users of the clients which access the licensed resources during a tracking period.

7. The method as recited in claim 1, wherein the configuration data includes authentication data corresponding to users of the plurality of clients to determine the number of unique users of the clients which access the licensed resources during a tracking period.

8. The method as recited in claim 1, wherein
the one or more applications are provided by one or more application servers; and
the configuration data is to determine for each of the clients which of the one or more application servers the respective client interacts with to obtain the licensed resources.

9. The method as recited in claim 1, wherein the topology data is to determine for each of the one or more applications which of the one or more resource servers the respective application interacts with to provide corresponding licensed resources.

10. One or more computer readable media comprising computer executable instructions which, when executed, direct a management service to:
collect configuration data from a plurality of clients in an enterprise network providing licensed resources to the clients;
collect topology data describing the arrangement of the enterprise network; and
combine the collected configuration data and topology data to measure the number of unique clients accessing the licensed resources during a tracking period.

11. One or more computer readable media as recited in claim 10, wherein the enterprise network includes:
one or more resources servers to provide the licensed resources; and
one or more application servers configured to provide one or more front-end applications to access the licensed resources from the one or more resource servers,
wherein the plurality of clients are connectable to the one or more application servers to obtain access the licensed resources via the one or more front end applications.

12. One or more computer readable media as recited in claim 10 further comprising instructions to measure the number of unique users accessing the licensed resources during the tracking period.

13. One or more computer readable media as recited in claim 10, wherein the management service interacts with a configuration agent deployed to one or more of the plurality of clients to collect the configuration data.

14. One or more computer readable media as recited in claim 10, wherein
the enterprise network includes a plurality of servers to provide the licensed resources to the plurality of clients; and
the management service interacts with a topology agent deployed to one or more of the plurality of servers to collect the topology data which describes the arrangement of the servers.

15. A system comprising:
one or more resources servers to provide licensed resources in an enterprise network;
one or more application servers configured to provide one or more front-end applications to access the licensed resources;
a plurality of clients connectable to the one or more application servers to obtain access the licensed resources via the one or more front-end applications; and
a management service to:
collect configuration data from the plurality of clients;
collect topology data describing the arrangement of the enterprise network; and
based on the configuration data combined with the topology data, measure usage of the licensed resources by the plurality of clients.

16. A system as recited in claim 15, wherein the management service is provided via a server which is:
communicatively coupled to the enterprise network; and
separate from the one or more resource servers and the one or more application servers.

17. A system as recited in claim 15, wherein one said resource server is configured to execute one or more modules to provide the management service.

18. A system as recited in claim 15, wherein the management service interacts with a topology agent deployed on one or more of the resources servers to collect the topology data.

19. A system as recited in claim 15, wherein the management service interacts with a configuration agent deployed to one or more of the clients to collect the configuration data.

20. A system as recited in claim 15, wherein:
the configuration data is to determine for each of the clients which of the one or more application servers the respective client interacts with to obtain the license resources; and
the topology data is to determine for each front-end application which of the one or more resource servers the respective application interacts with to provide corresponding licensed resources.
